(19) United States
(12) Patent Application Publication
(10) Pub. No.: US 2018/0221899 A1
(43) Pub. Date: Aug. 9, 2018

(54) SYSTEM AND APPARATUS FOR AN ELECTRIC PRESSURE WASHER

(71) Applicant: Mi-T-M Corporation, Peosta, IA (US)

(72) Inventor: Michael John Steffen, Dubuque, IA (US)

(21) Appl. No.: 15/424,194

(22) Filed: Feb. 3, 2017

(51) Int. Cl. B05B 7/16; B08B 3/02; B08B 3/10; B05B 7/22; B05B 7/04; B05B 15/06

(52) U.S. Cl. CPC B05B 7/1693; B08B 3/026; B05B 15/061; B05B 7/22; B05B 7/0408; B08B 3/10

(57) ABSTRACT

An electric power washer apparatus and system including a water inlet that receives pressurized water, a pump fluidly connected to the water inlet, a motor powering the pump to increase the pressure of the pressurized water, a first heat exchanger fluidly connected to the pump, the first heat exchanger including an in-cast heating element, a gun fluidly connected to the first heat exchanger, and preferably a second heat exchanger connected in series or parallel to the first heat exchanger to provide additional heating to the fluid as it passes through the system. The system further preferably includes an unloader, a pressure regulating valve, a thermostat, a detergent system, and may include a variety of styles of heat exchangers so long as at least one is an in-cast heat exchanger. These other styles of heat exchangers may include a tank style heating element or an encased style heating element.

### FIELD OF THE INVENTION

The present invention is directed to a system and apparatus for an electric pressure washer. Preferably, but not exclusively, the system of the present invention includes a heat exchanger in which the water is never heated in a tank or exposed to a heating element. In one embodiment, the heat exchanger of the present invention may be an in-cast type heat exchanger and may be combined with a plurality of other heat exchangers, which may vary in type. Preferably, the electric power washer present invention is able to heat pressurized water quickly and efficiently.

### BACKGROUND OF THE INVENTION

Frequently, electricity is used power a motor that turns a pump to pressurize the water and a separate heating element, which can be either gas or electric, is used to heat a tank of water. In many of the current electric pressure washers, the heat exchanger includes a heating element that is either a tank style heating element or an encased style heating element. A tank style heating element submerses a coil in a tank of hot water and the pressurized water then flows through the submersed coil. This requires the tank of hot water be initially heated to the desired temperature. These tank style systems are slow to heat the pressurized water, require a constant heating of the tank water, and thus are very inefficient.

The other current option is the encased element style of heating elements which has an element inside of a tube. The pressurized water flows through this tube and circulates about the heating element. This places the heating element in direct contact with the water. This encased element style of heating element presents many problems. For example, the minerals in the water are typically drawn to the element and form a scale which decreases the efficiency of the heating element while simultaneously increasing the maintenance requirements of the unit.

It is therefore desirable to have an electric pressure washer that overcomes one or more of the problems of the prior art and improves upon the state of the art.

Accordingly, it is an objective of the claimed invention to improve upon the state of the art.

Another object of the present invention is an electric pressure washing system which minimizes maintenance of the heating element in the unit.

Another object of the present invention is an electric pressure washer which is able to heat pressurized water at an improved rate.

Another object of the present invention is an electric pressure washer which provides higher temperature rises over an extended spray time.

Another object of the present invention is an electric pressure washer which minimizes scale buildup within the heat exchanger.

These and other objects, features, or advantages of the present invention will become apparent from the following specification, figures, and claims.

### BRIEF SUMMARY OF THE INVENTION

The present invention preferably includes a power washing machine where the power washing machine includes a base frame to which a plurality of panels may be secured. A plurality of heat exchangers are secured directly or indirectly to the base frame. At least one of the plurality of heat exchangers includes a heating element surrounded by a metallic body, which is an in-cast heating element. Within the metallic body water tubing is also incorporated. In this manner, the in-cast heating element is not exposed to water within the heat exchanger.

In one embodiment, the power washer apparatus of the present invention includes a base frame on which a first heat exchanger is secured, directly or indirectly. The first heat exchanger includes the in-cast heating elements surrounded by a body and water tubing travelling through the body, the water tubing including an interior through which fluid flows and an exterior. The in-cast heating element is located within the body and outside the water tubing interior. This arrangement prevents the buildup of scale or other deposits on the heating element.

The apparatus further preferably includes a pressure unit, which is generally comprised of an electric motor and a pressurizing pump. Tubing connects the pump to the heat exchanger and a gun is operatively connected to the heat exchanger to dispense pressurized fluid. The power washer apparatus may include a detergent system including a tank of detergent solution, a detergent metering valve, and a hose operatively connecting the detergent system to the gun.

In another embodiment, the present invention includes a second heat exchanger. Preferably, the second exchanger also includes an in-cast heating element. Alternatively, the power washer apparatus of the present invention can use multiple heat exchangers with a variety of heating elements, including an encased heating element, a tank style heating element, or an in-cast element style heating element. These heat exchangers can be arranged in series or in parallel.

In another embodiment, the power washer of the present invention further includes an unloader, a pressure regulating value, a thermostat, and other control systems to ensure proper operation of the power washer system.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspects may be used in combination with other examples or aspects of the invention and that the drawing and preferred embodiments are not to be limiting.

FIG. 1 shows a perspective view of the power washing apparatus of one embodiment of the power washing apparatus of the present invention.

FIG. 2 shows a fluid flow diagram of an embodiment of the present invention.

FIG. 3 shows an exploded view of the power washing apparatus of another embodiment of the power washing apparatus of the present invention.

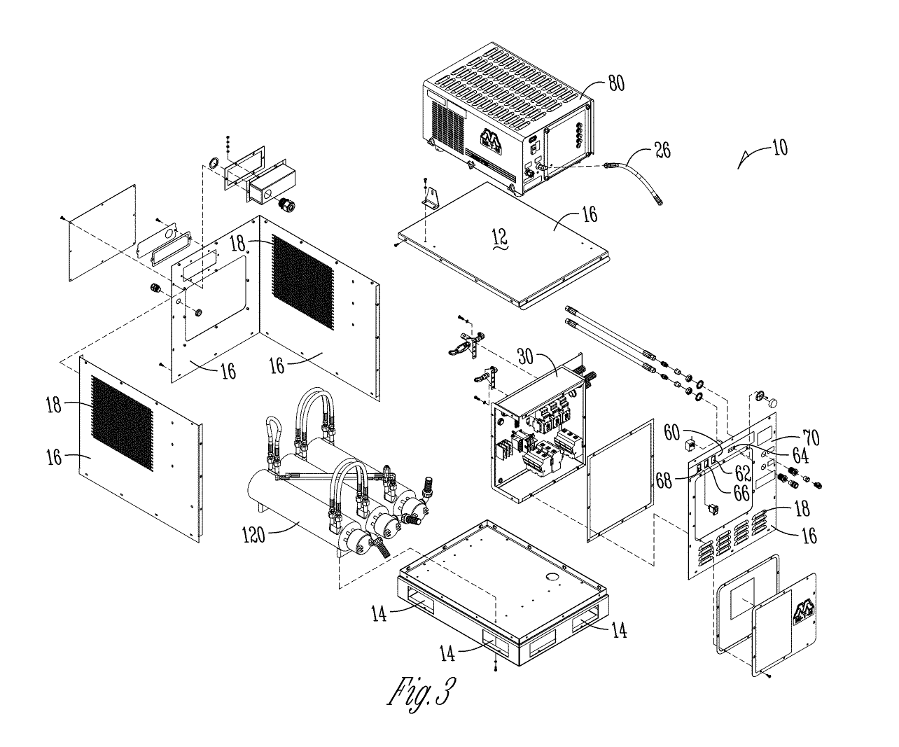

FIG. 4 shows an embodiment of the gun and hose arrangement of the present invention.

FIG. 5 shows an exploded view of the high pressure unit assembly of the present invention.

FIG. 6 shows an embodiment of a heat exchanger arrangement that may be used in the present invention.

FIG. 7 shows another embodiment of the heat exchanger arrangement that may be used in the present invention.

FIG. 8 shows cross-section of one embodiment of the heat exchanger that may be used in the present invention.

### DETAILED DESCRIPTION OF THE INVENTION

The following definitions and introductory matters are provided to facilitate an understanding of the present invention.

Numeric ranges recited within the specification, including ranges of “greater than,” “at least,” or “less than” a numeric value, are inclusive of the numbers defining the range and include each integer within the defined range.

The singular terms “a”, “an”, and “the” include plural referents unless context clearly indicates otherwise. Similarly, the word “or” is intended to include “and” unless the context clearly indicate otherwise. The word “or” means any one member of a particular list and also includes any combination of members in that list.

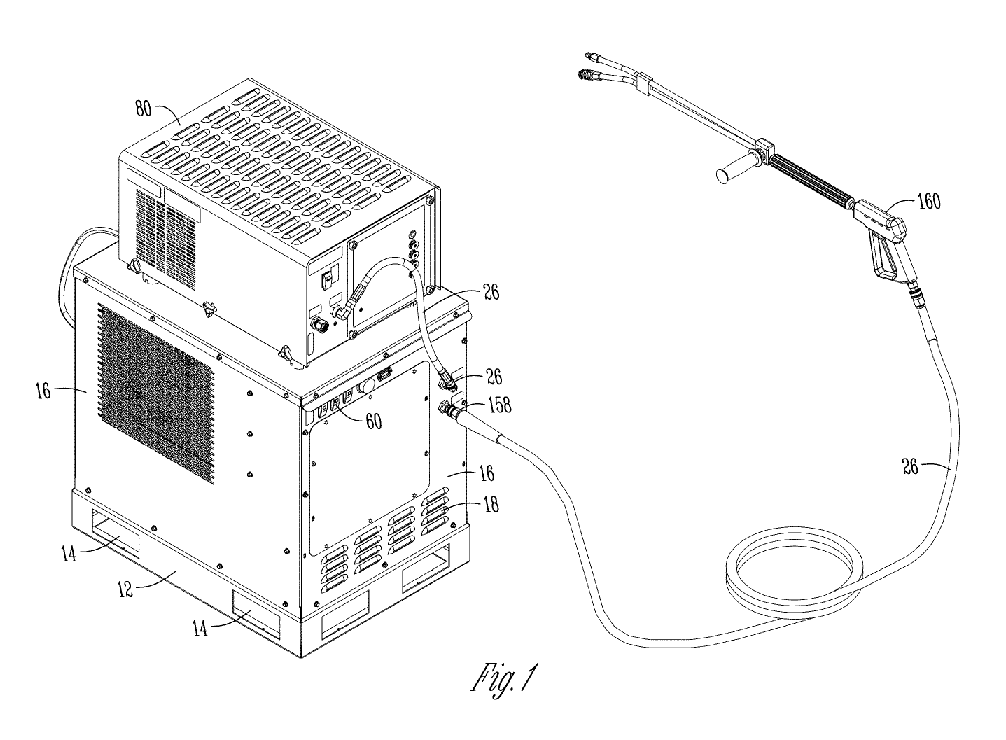

One example of the present invention is shown in FIG. 1. This example shows an embodiment of the electric power washer of the present invention. The electric power washer 10 generally includes a base frame 12 which may include forklift access openings 14. A plurality of panels 16 that may include ventilation openings 18 and other access panels are secured to the frame. The heat exchanger 120 is secured within the panels 16 and forms a heater module that can be used with an included or stand-alone high pressure unit 80. The included high pressure unit 80 is secured either within or, as shown, above, the panels 16. A variety of controls 60 can be included in a convenient place to allow for easy access and operation by user. Ultimately, a gun 160 is secured to the power washing unit 10 with a high pressure hose 26. Other high pressure hoses 26 may be used to connect various components of the present invention.

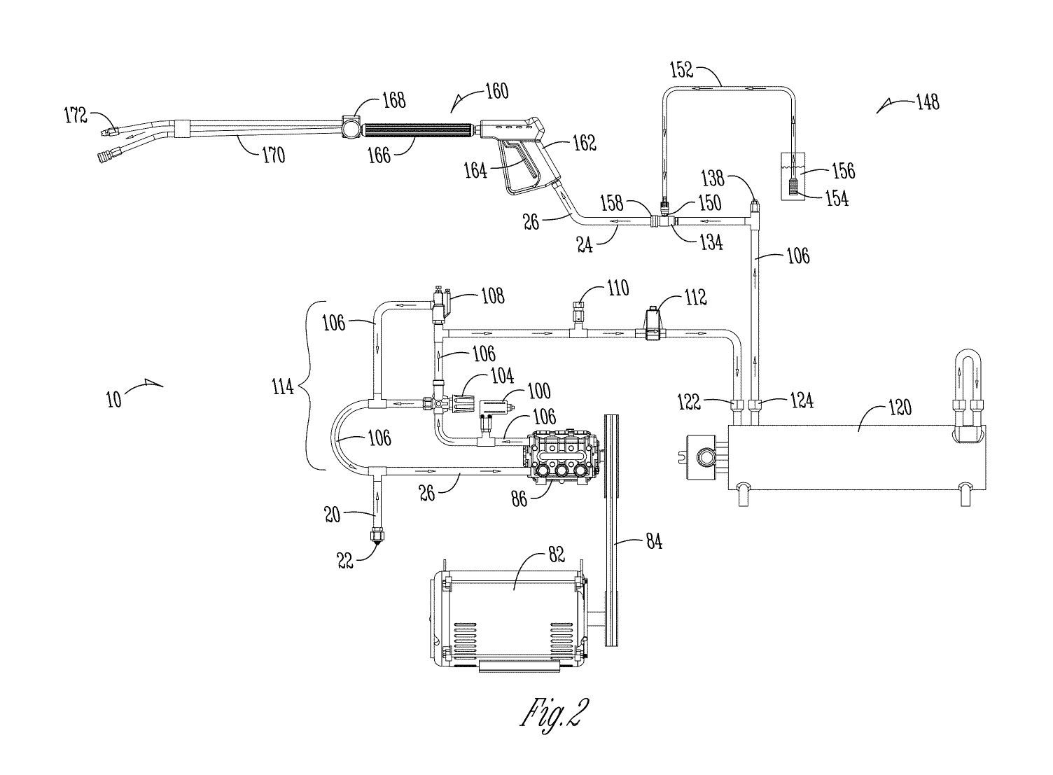

A flow diagram of the present invention is shown in FIG. 2. As shown in FIG. 2, the power washer assembly 10 includes a water inlet 20 that includes a water strainer 22. Ultimately, there is a high pressure water outlet from the system 24 that is connected though a high pressure hose 26 to the gun 160. As shown in FIG. 2, pressurized water from a garden hose enters the water inlet 20 and is then directed into a pump 86. The pump is operated by a motor 82 that is preferably an electric motor. The electric motor is preferably operatively connected to the pump by a drive belt 84. When water is pressurized in the pump 86, it leaves the pump 86 and travels through pressurized tubing 106 past a pressure switch 100, where pressure can be relieved if necessary, and on past a pressure trapping unloader. The pressure trapping unloader can reroute pressurized water through a bypass loop 114, if necessary. If it is not necessary, water will travel further upstream through pressurized tubing 106 and past a pressure regulating value 108. Here again, if pressure exceeds the pressure set through the adjustable pressure regulating valve 108, the water can be sent through a bypass loop 114. If not, the water travels further downstream and past a safety relief valve. This is another safety mechanism which allows for pressure to be released if necessary.

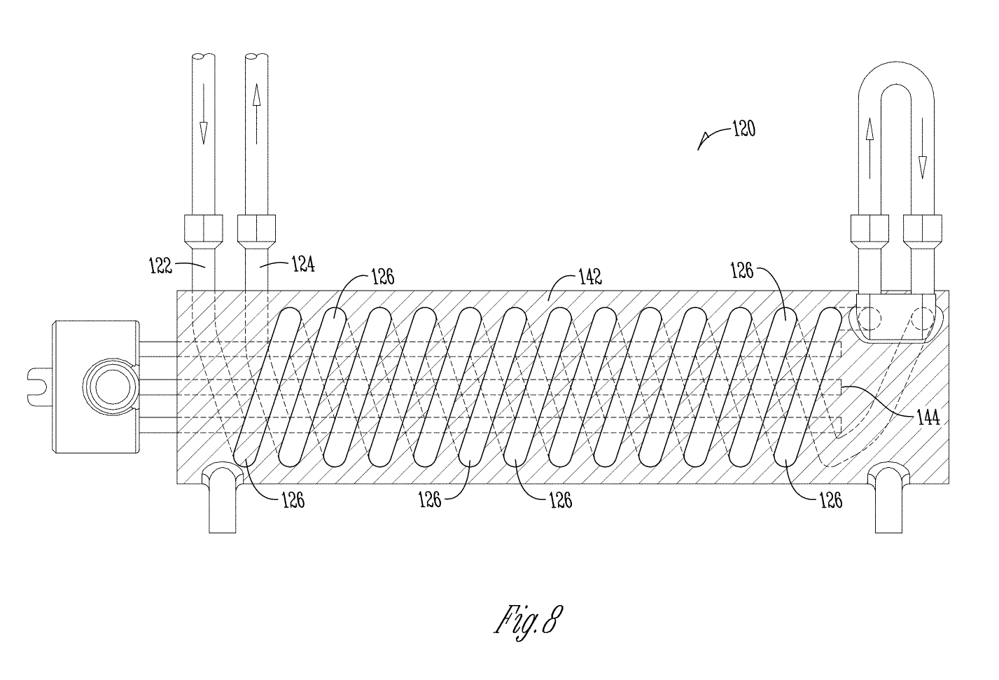

Next, the water travels past the flow valve 112 and into the water inlet 122 of the heat exchanger 120. The heat exchanger 120 is shown in FIG. 8 and preferably is an in-cast heat exchanger where in the water hoses 126 are helically wound around and through the body 142 of the heat exchanger 120. The body 142 of the heat exchanger is preferably solid cast aluminum. The water tubing 126 is preferably cast into the aluminum body 142 as are the heating elements 144. The heating elements 144 are never exposed to the water that travels within the tubing 126. Instead, the heating elements 144 heat the aluminum body 142. Because the body 142 is metal, it heats rapidly and transfers heat easily. This requires that it be mounted appropriately onto the base frame 12. There may be one or more intermediate members between the heat exchanger 120 and the base frame 12, but inclusion of additional elements between the heat exchanger 120 and the base frame 12 is to be considered as if the heat exchanger 120 is still secured to the base frame 12.

The heating elements 144 of the heat exchanger 120 are never exposed to the water that travels through the high pressure piping 126. This prevents the water from contacting the heating elements and minimizes any potential scale buildup. It also enables the water to be heated rapidly. After the water is heated, it exits the heat exchanger 120 through outlet 124. The water then travels through additional high pressure tubing 106 past a thermostat 138. The thermostat is operatively connected to a control system which will turn on the heat exchanger 120 if the temperature is too low and, correspondently, turn off the heat exchanger 120 if the temperature gets too high.

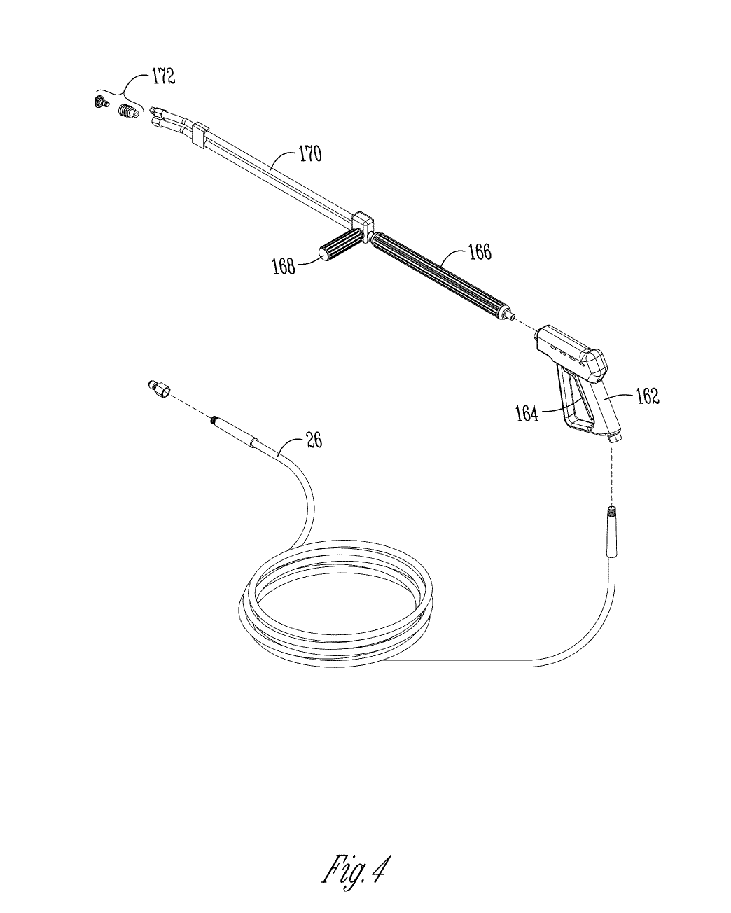

The heated water then flows past the detergent system 148. If no detergent is desired, the water will flow through a t-valve 134 and past the detergent metering valve 150 to the gun 160. If detergent is desired, the detergent system 148 will take the liquid detergent solution 156 and incorporate it into the water stream. This is done by allowing the detergent solution 156 to travel through a detergent strainer 154 through a detergent hose 152 and into the detergent metering valve 150, where it is joined with the high pressure heated water flow. The water flow is dispensed by the user through the gun 160. As shown in more detail in FIG. 4, the trigger gun 160 includes a handle 162, a trigger 164, an insulated lance 166, a secondary handle 168, and a dual lance 170, which may include one or more nozzles 172 secured as desired to one or both of the lances 170.

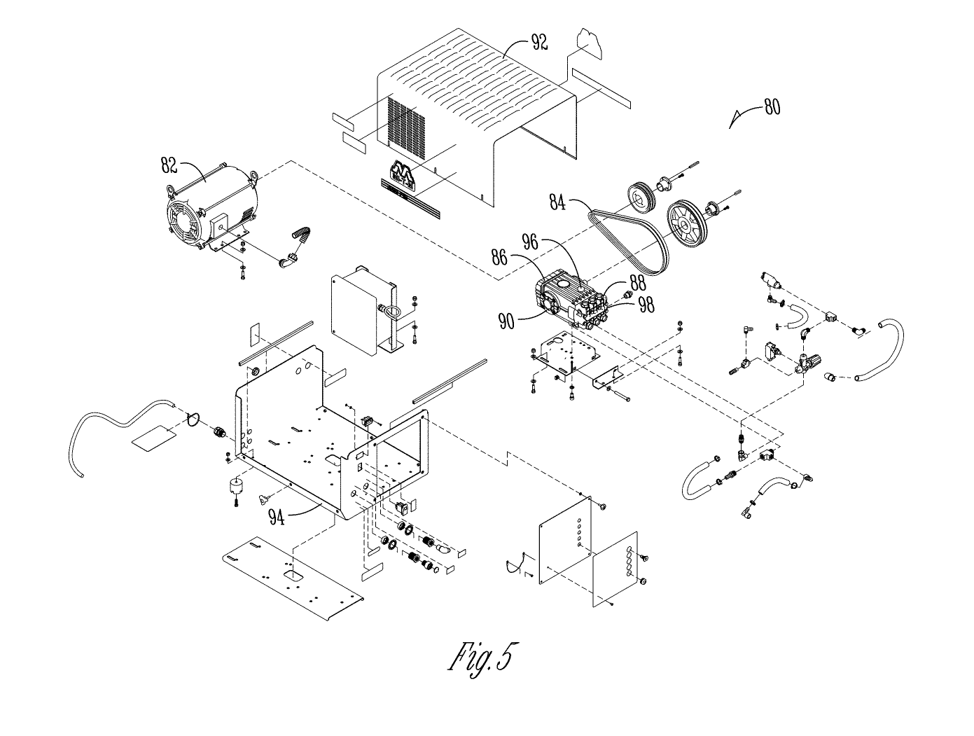

As shown in more detail in FIG. 5, the high pressure unit 80 includes an electric motor 82 which is operatively connected by a drive belt 84 to a high pressure pump 86. The high pressure unit 80 is encapsulated by a cover 92 that is secured to a base frame 94. The high pressure pump 86 includes a manifold 88 and a crank case 90. The high pressure pump 86 further includes pump inlet 96 and pump outlet 98. Water traveling through the pump is sent by high pressure hoses 126 to the heat exchanger 120.

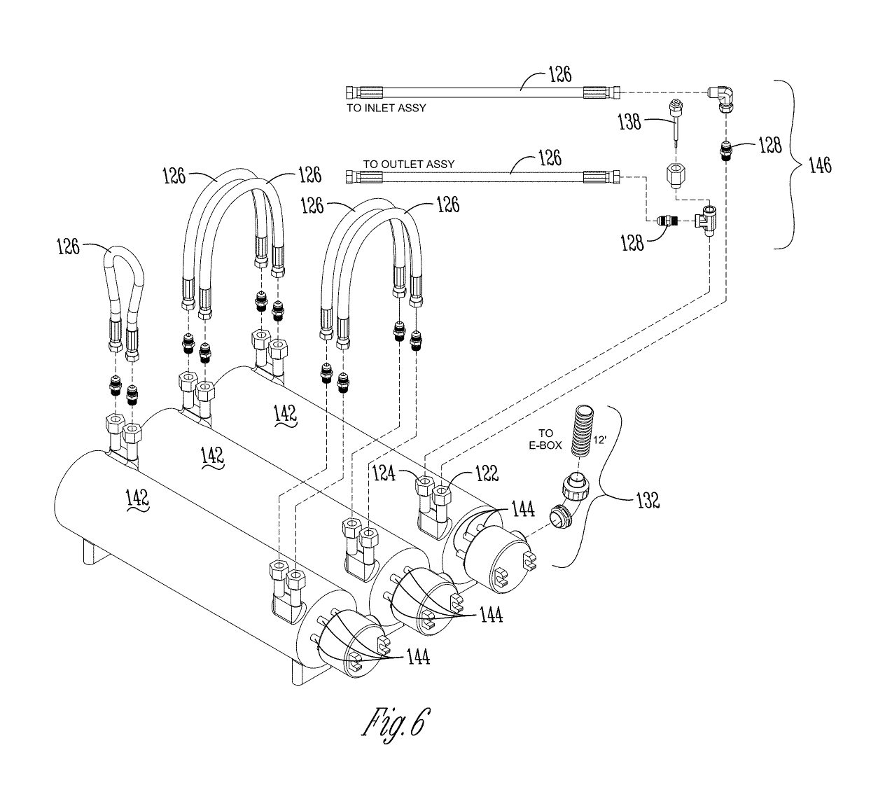

An example of one embodiment of a plurality of heat exchangers is shown in FIG. 6. In this arrangement, the heat exchangers 120 include three heat exchanger bodies 142. In this example, each of the bodies 142 includes an in-cast heating element 144. Alternatively, the heat exchanger arrangement can include one in-cast heat exchanger 120 coupled with a tank style heat exchanger or coupled with an encased element style heat exchanger. Any number of heat exchangers may be used in any arrangement of heat exchangers, so long as at least one of the heat exchangers includes in-cast element 144 to provide the rapid and consistent water heating capability that is desired.

As shown further in FIG. 6, the heat exchanger arrangement which includes three bodies 142 has an inlet 122 to the first body 142 and then each of the bodies is connected by high pressure hoses 126 until ultimately the water reaches the outlet 124. Each of the heating elements 144 is electrically powered and an electric power cord is secured to the heat exchanger through a coupling 132.

From the outlet 124, the heated pressurized water travels through a variety of high pressure hoses 126 and a variety of connecters 146, which may include nipples 128 or other connecters such as t-connectors or elbow connectors. The water passes a thermostat 138 which will turn off the heat exchanger 120 if the water gets too hot or turn on the heat exchanger 120 if the water gets too cold. The water then travels through additional high pressure hoses 126 to reach the outlet assembly.

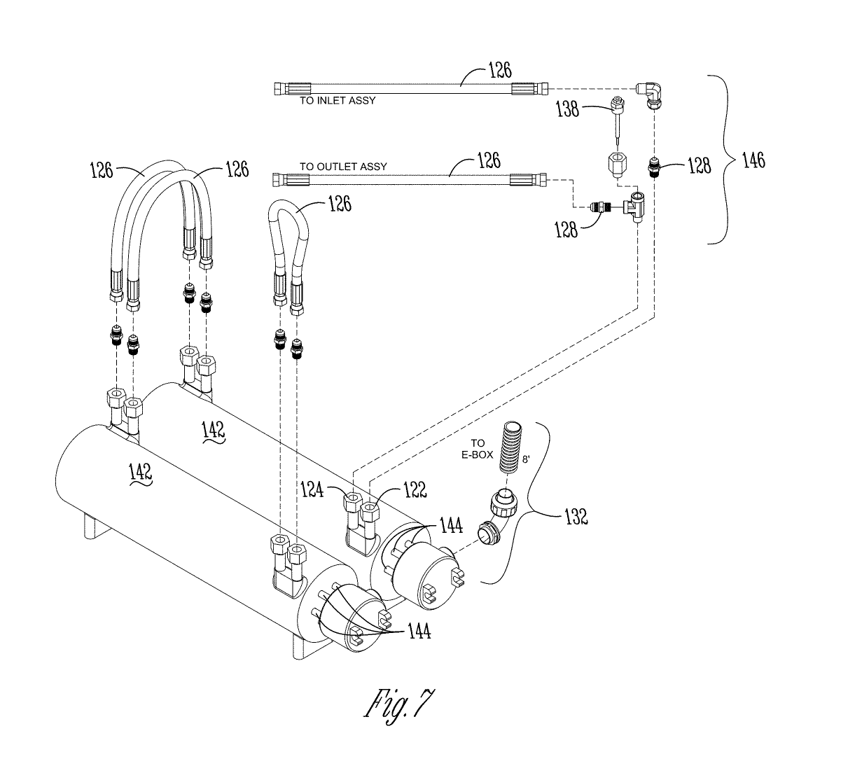

An alternative arrangement is shown in FIG. 7 where there is a two body heat exchanger arrangement, which operates in the same manner as described above with regard to the three heat exchanger unit shown in FIG. 6. Two, three, four, or many multiple heat exchangers can be used as desired.

In operation, a pressurized water source, such as a garden hose connection, is connected to the power washer assembly 10 and into the water inlet 20. When the water is turned on, water will flow through a water strainer 22 and into the high pressure pump unit 80. An unloader can bypass the water when the trigger gun is closed. To protect the pump from heated water during this bypass stage, a heat pump valve will preferably open at or above 125 degrees Fahrenheit or at or above 52 degrees Celsius, allowing the heated water to escape. The heat dump valve automatically resets when the water cools. Attached to the pump is a pressure switch that controls the time/delay shut down feature.

After the high pressure water exits the pump, it enters a safety system which protects the operator from danger. The safety system contains a flow switch which must signal that water is flowing before it allows the heaters to turn on. From there, the water flows through the heat exchanger inlet where it is heated when the heat exchanger switches are on. As the water exits the heat exchanger outlet, it passes an adjustable thermostat which senses the water temperature and shuts off the heat exchangers if the water gets too hot. If the unloader fails to bypass water, or the heat exchanger remains on when the trigger gun is closed, the safety relief valve will relieve and allow water to exit safely. During normal operation, the trapped pressure in bypass mode may be lowered by the pressure regulating valve which will relieve a small amount of water into the bypass loop. This will lower the trap between the unloader and the gun.

The heated water then flows through the high pressure hose and to the trigger gun assembly which allows the operator to control the water supply. When the trigger gun is open, the water flows through the adjustable pressure dual lance and exits the nozzle. In this manner, an electric pressure washer is provided that operates in a safe and efficient manner and accomplishes the objects of the present invention.

It will be appreciated by those skilled in the art that other various modifications could be made to the pressure washer apparatus and system as described above without parting from the spirit and scope of this invention. All such modifications and changes fall within the scope of the claims and are intended to be covered there by.

What is claimed is:

1. A power washer apparatus, the apparatus comprising:
a base frame;
a first heat exchanger secured to the base frame, wherein the first heat exchanger includes:
a heating element surrounded by a body;
water tubing traveling through the body, the water tubing including an interior through which fluid flows and an exterior; and
wherein the heating element is located in the body and outside of the water tubing interior;
a pressure unit, the pressure unit including:
an electric motor;
a pressure pump operatively connected to the electric motor;
tubing connecting the pump to the heat exchanger; and
a gun operatively connected to the heat exchanger.

2. The power washer apparatus of claim 1 further comprising a detergent system, the detergent system including a tank of detergent solution, a detergent metering valve, and a hose operatively connecting the detergent system to the gun.

3. The power washer apparatus of claim 1 further comprising a second heat exchanger.

4. The power washer apparatus of claim 3 wherein the first heat exchanger and the second heat exchanger are connected in parallel.

5. The power washer apparatus of claim 3 wherein the first heat exchanger and the second heat exchanger are connected in series.

6. The power washer apparatus of claim 3 wherein the second heat exchanger includes a tank style heating element.

7. The power washer apparatus of claim 3 wherein the second heat exchanger includes an encased element style heating element.

8. The power washer apparatus of claim 3 wherein the second heat exchanger includes a second in-cast style heat exchanger.

9. An electrically heated power washing system, the system comprising:
a water inlet that receives pressurized water;
a pump fluidly connected to the water inlet;
a motor powering the pump to increase the pressure of the pressurized water;
a first heat exchanger fluidly connected to the pump, the first heat exchanger including an in-cast heating element; and
a gun fluidly connected to the first heat exchanger.

10. The system of claim 9 further comprising an unloader fluidly connected to the pump.

11. The system of claim 9 further comprising a pressure regulating valve fluidly connected to the pump.

12. The system of claim 9 further comprising a thermostat fluidly connected to the first heat exchanger.

13. The system of claim 9 further comprising a detergent system fluidly connected to the heat exchanger.

14. The system of claim 9 further comprising a second heat exchanger fluidly connected to the first heat exchanger.

15. The system of claim 14 wherein the second heat exchanger includes an in-cast heating element.

16. The system of claim 14 further comprising a third heat exchanger fluidly connected to the second heat exchanger.

17. An electric power washer comprising:
a water inlet;
a pump;
a first heat exchanger, the first heat exchanger including an in-cast heating element;
a gun operatively connected to the first heat exchanger; and
a plurality of tubing connections, wherein one of the plurality of tubing connections is between the water inlet and the pump, wherein one of the plurality of tubing connections is between the pump and the first heat exchanger.

18. The electric power washer of claim 17 further comprising a second heat exchanger, wherein one of the plurality of tubing connections is between the first heat exchanger and the second heat exchanger.

19. The electric power washer of claim 18 wherein the second heat exchanger includes an in-cast heating element.

20. The electric power washer of claim 17 further comprising a thermostat.
